(19) United States
(12) Patent Application Publication
(10) Pub. No.: US 2017/0152348 A1
(43) Pub. Date: Jun. 1, 2017

(54) POLYIMIDE AND POLYIMIDE FILM

(71) Applicant: TAIFLEX Scientific Co., Ltd., KAOHSIUNG (TW)

(72) Inventors: Yi-Kai Fang, KAOHSIUNG (TW); Tsung-Tai Hung, KAOHSIUNG (TW); Chiao-Pei Chen, KAOHSIUNG (TW); Pin-Shiuan Chen, KAOHSIUNG (TW); Ching-Hung Huang, KAOHSIUNG (TW)

(21) Appl. No.: 15/016,288

(22) Filed: Feb. 5, 2016

(30) Foreign Application Priority Data
Dec. 1, 2015 (TW) 104140084

(51) Int. Cl. C08G 73/10; C08J 5/18

(52) U.S. Cl. CPC C08G 73/1082; C08J 5/18; C08J 2379/08

(57) ABSTRACT

A polyimide is provided. The polyimide includes a repeating unit represented by formula 1.

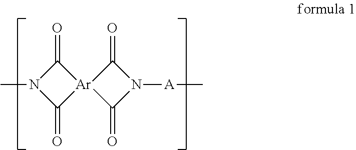

In formula 1, Ar is a tetravalent residue obtainable from a tetracarboxylic dianhydride containing a fluorine-containing aromatic group or an oxygen-containing aromatic group, and A is

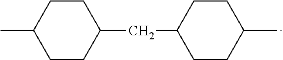

### CROSS-REFERENCE TO RELATED APPLICATION

This application claims the priority benefit of Taiwan application serial no. 104140084, filed on Dec. 1, 2015. The entirety of the above-mentioned patent application is hereby incorporated by reference herein and made a part of this specification.

### BACKGROUND OF THE INVENTION

Field of the Invention

The invention relates to a polyimide and a polyimide film, and particularly relates to a polyimide and a polyimide film with high transparency.

Description of Related Art

Polyimide resins have been applied in various fields of automotive materials, aeronautical materials, insulating materials, and electrical/electronic materials, such as liquid-crystal alignment films, etc., due to having an excellent thermal characteristic, mechanic characteristic, and electric characteristic. Monomers containing aromatic groups are usually used to prepare the polyimide resins to achieve good thermal stability. However, the films prepared from the polyimide resins show brown or yellow whereby not only the light transmittance is affected seriously but the applicability is limited thereto. In a known technique, various studies are proceeded to improve the light transmittance of the polyimide resins. However, the thermal stability is decreased along with the improvement of the light transmittance. Thus, the development of the polyimide resin with high light transmittance and high thermal stability is still the most eager developmental goal in this related field currently.

### SUMMARY OF THE INVENTION

The invention provides a polyimide and a polyimide film having good light transmittance, transparency, and thermal stability.

The invention provides a polyimide including a repeating unit represented by formula 1:

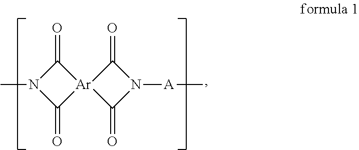

wherein Ar is a tetravalent residue obtainable from a tetracarboxylic dianhydride having a fluorine-containing aromatic group or an oxygen-containing aromatic group, and

A is

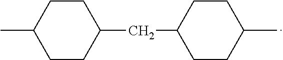

According to an embodiment of the invention, Ar is

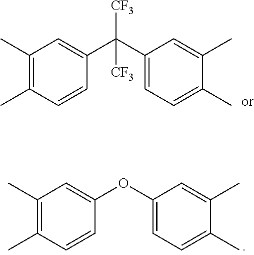

According to an embodiment of the invention, the glass transition temperature of the polyimide is in the range of 250° C. to 350° C.

According to an embodiment of the invention, the UV cut-off wavelength of the polyimide is in the range of 320 nm to 380 nm.

According to an embodiment of the invention, the polyimide has the light transmittance of 70% or more at the wavelength of 370 nm.

According to an embodiment of the invention, the polyimide has the light transmittance of 80% to 90% at the wavelength of 400 nm.

According to an embodiment of the invention, the polyimide has the light transmittance of 85% to 95% at a wavelength of 550 nm.

According to an embodiment of the invention, the polyimide has a C.I.E(L*a*b*) color space value and a value of L* is in a range of 94 to 99, a value of a* is in a range of −2.5 to 1, and a value of b* is in a range of −5 to 5.

According to an embodiment of the invention, the polyimide has the viscosity in the range of 150 to 50,000 cps.

The invention also provides a polyimide film including the polyimide.

Based on the above description, the polyimide of the invention is made from a dianhydride monomer having a fluorine-containing aromatic group or an oxygen-containing aromatic group and a specific diamine monomer, thereby the polyimide and the polyimide film including the same are capable of having good light transmittance, transparency, and thermal stability.

In order to make the aforementioned features and advantages of the disclosure more comprehensible, embodiments are described in detail below.

### DESCRIPTION OF THE EMBODIMENTS

In the specification, scopes represented by “a numerical value to another numerical value” are schematic representations in order to avoid listing all of the numerical values in the scopes in the specification. Therefore, the recitation of a specific numerical range covers any numerical value in the numerical range and a smaller numerical range defined by any numerical value in the numerical range, as is the case with any numerical value and a smaller numerical range thereof in the specification.

In the specification, skeleton formulas are sometimes used to represent structures of polymers or groups. Such representation can omit carbon atoms, hydrogen atoms, and carbon-hydrogen bonds. Certainly, structural formulas with clear illustrations of atoms or atomic groups are definitive.

To prepare a polyimide having good light transmittance, transparency, and thermal stability, the invention provides a polyimide capable of achieving the advantages. In the following, embodiments are described below as examples according to which the present invention can be surely implemented.

An embodiment of the present invention provides a polyimide including a repeating unit represented by formula 1:

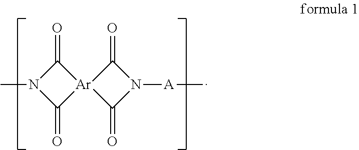

In formula 1, Ar is a tetravalent residue obtainable from a tetracarboxylic dianhydride having a fluorine-containing aromatic group or an oxygen-containing aromatic group. That is, Ar is the residue of the tetracarboxylic dianhydride having the fluorine-containing aromatic group or the oxygen-containing aromatic group except two carboxylic acid anhydride groups (—(CO)₂O). In the specification, the tetracarboxylic dianhydride having the fluorine-containing aromatic group or the oxygen-containing aromatic group is also called a dianhydride monomer.

In particular, Ar is

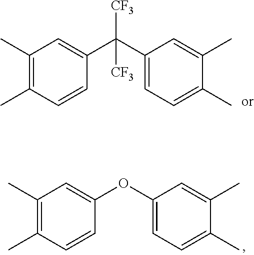

for example. That is, in the embodiment, the tetracarboxylic dianhydride having the fluorine-containing aromatic group may be 4,4′-(hexafluoro-isopropylidene) diphthalic anhydride (6FDA), and the tetracarboxylic dianhydride having the oxygen-containing aromatic group may be bis-(3-phthalyl anhydride) ether (ODPA).

In formula 1, A is

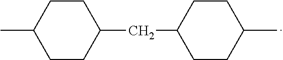

That is, A is the residue of 4,4′-diaminodicyclohexyl methane (MBCHA) except two amino groups (—NH₂). From another point of view, 4,4′-diaminodicyclohexyl methane is also called a diamine monomer in the specification.

It should be noted that the polyimide is prepared from the tetracarboxylic dianhydride having the fluorine-containing aromatic group or the oxygen-containing aromatic group as the dianhydride monomer and 4,4′-diaminodicyclohexyl methane as the diamine monomer, so that the polyimide has good light transmittance, transparency, and thermal stability in the embodiment. Thus, the polyimide can be used in some fields that other transparent resins cannot be used therein. For example, caps of optical components, such as computer-controlled displays, liquid crystal displays, large electronic displays, etc., polarizing plates, substrates of solar cells, plastic lens, and the like.

In particular, the glass transition temperature of the polyimide is in the range of 250° C. to 350° C., in the embodiment. The UV cut-off wavelength of the polyimide is in the range of 320 nm to 380 nm, preferably from 320 nm to 350 nm, in the embodiment. The polyimide has the light transmittance of 70% or more at the wavelength of 370 nm, in the embodiment. The polyimide has the light transmittance of 80% to 90% at the wavelength of 400 nm, in the embodiment. The polyimide has the light transmittance of 85% to 95%, preferably 90% to 95, at the wavelength of 550 nm, in the embodiment. In the embodiment, the polyimide has the C.I.E(L*a*b*) color space value and the value of L* is in the range of 94 to 99, the value of a* is in the range of −2.5 to 1, and the value of b* is in the range of −5 to 5. Specifically, the CIE L*a*b* color space is constituted by the brightness of the color (L*=0 indicates black; L*=100 indicates white), a position between red/magenta and green (a negative value of a* indicates that color inclines to green; a positive value thereof indicates that color inclines to magenta), and a position between yellow and blue (a negative value of b* indicates that color inclines to blue; a positive value thereof indicates that color inclines to yellow). In view of this, when the value of L* is in the range of 94 to 99, the value of a* is in the range of −2.5 to 1, and the value of b* is in the range of −5 to 5, the polyimide has good transparency, and the polyimide film prepared therefrom may not appear yellow.

It should be noted that the polyimide is prepared from the tetracarboxylic dianhydride having the fluorine-containing aromatic group or the oxygen-containing aromatic group as the dianhydride monomer and 4,4′-diaminodicyclohexyl methane as the diamine monomer in the embodiment, so that the polyimide has good adhesive force to copper foil. Thus, the polyimide is suitable for the production of flexible copper substrates.

In addition, since the price of 4,4′-diaminodicyclohexyl methane is cheap, the manufacturing cost of the polyimide may be reduced by using 4,4′-diaminodicyclohexyl methane as the diamine monomer to prepare the polyimide. Thus, it has a good commercial value.

In addition, the polyimide including the repeating unit represented by formula 1 is derived from an imidization reaction of the dianhydride monomer with the diamine monomer as mentioned above. Specifically, the imidization reaction is performed in a solvent. The solvent is such as N-methyl-2-pyrrolidone (NMP), N,N-dimethylacetamide (DMAc), dimethyl sulfoxide (DMSO), dimethylformamide (DMF), hexamethylphosphoramide, or m-cresol. Besides, the imidization ratio of the imidization reaction is 100%.

In addition, the viscosity of the polyimide is in the range of 150 cps to 50,000 cps, preferably 2,000 cps to 30,000 cps, in the embodiment. Specifically, a coating process is difficult to perform and the applicability of the polyimide is limited when the viscosity of the polyimide is more than 50,000 cps.

In addition, the polyimide of the present invention may exist in form of film, powder, or solution, etc. Hereinafter, the polyimide is illustrated in form of film as an example.

Another embodiment of the present invention provides a polyimide film including the polyimide according to any of the above-mentioned embodiments. The thickness of the polyimide film is in the range of about 12 m to 25 min in the embodiment.

It should be noted that since the polyimide has good light transmittance, transparency, thermal stability, adhesive force with copper foil, and low manufacturing cost as mentioned above, the polyimide film may also have good light transmittance, transparency, thermal stability, adhesive force with copper foil, and low manufacturing cost. Therefore, the applicability and the commercial value of the polyimide film are increased significantly.

The features of the invention are more specifically described in the following with reference to Examples 1-2 and Comparative Example 1. Although the following Examples 1-2 are described, the material used, the material usage amount and ratio, processing details and processing procedures, etc. can be suitably modified without departing from the scope of the invention. Accordingly, restrictive interpretation should not be made to the invention based on the examples described below.

The information of the main materials used to prepare the polyimide film of Examples 1-2 and Comparative Example 1 is shown below.

4,4′-diaminodicyclohexyl methane (MBCHA): purchased from the TCI Company.

4,4′-diamino-2,2′-bis (trifluoromethyl) biphenyl (TFMB): purchased from the Jin-Yu Tech Co., Ltd.

4,4′-(hexafluoro-isopropylidene) diphthalic anhydride (6FDA): purchased from the Jin-Yu Tech Co., Ltd.

bis-(3-phthalyl anhydride) ether (ODPA): purchased from the JFE Chemical Co., Ltd.

N-methyl-2-pyrrolidone (NMP): purchased from the Taiwan Maxwave Co., Ltd.

### Example 1

In a water bath (at room temperature), 0.152 mol (32.14 g) of MBCHA was dissolved in 400 g of NMP as a solvent. In a water bath (at room temperature), 0.152 mol (67.86 g) of 6FDA was added into the above-mentioned solution. Then, a polyamic acid solution with a solid content of 20% was obtained after reacting for 16 hours in a water bath (at room temperature). After that, 30 ml of the polyamic acid solution was coated on a copper foil (the thickness thereof is 12 μm) by a blade coating method, and was baked at 140° C. for 10 minutes to remove NMP. Then, the copper foil coated with the polyamic acid solution was placed in a nitrogen environment at 300° C. to perform a imidization reaction (dehydrating cyclization) for 30 minutes, so that the polyimide film placed on the copper foil of Example 1 was obtained, wherein the imidization ratio thereof is 100%. Finally, the copper foil was removed by etching to obtain the polyimide film of Example 1, wherein the thickness thereof is about 25 m measured by performing a thickness measurement using a Litematic device (the series 318 Model VL-50A by Mitutoyo America Corporation).

### Example 2

In a water bath (at room temperature), 0.345 mol (72.74 g) of MBCHA was dissolved in 720 g of NMP as a solvent. In a water bath (at room temperature), 0.345 mol (107.26 g) of ODPA was added into the above-mentioned solution. Then, a polyamic acid solution with a solid content of 20% was obtained after reacting for 24 hours in a water bath (at room temperature). After that, 30 ml of the polyamic acid solution was coated on a copper foil (the thickness thereof is 12 m) by a blade coating method, and was baked at 140° C. for 10 minutes to remove NMP. Then, the copper foil coated with the polyamic acid solution was placed in a nitrogen environment at 300° C. to perform a imidization reaction (dehydrating cyclization) for 30 minutes, so that the polyimide film placed on the copper foil of Example 2 was obtained, wherein the imidization ratio thereof is 100%. Finally, the copper foil was removed by etching to obtain the polyimide film of Example 2, wherein the thickness thereof is about 25 μm measured by performing a thickness measurement using a Litematic device (the series 318 Model VL-50A by Mitutoyo America Corporation).

### Comparative Example 1

In a water bath (at room temperature), 0.131 mol (41.89 g) of TFMB was dissolved in 400 g NMP as a solvent. In a water bath (at room temperature), 0.131 mol (58.11 g) of 6FDA was added into the above-mentioned solution. Then, a polyamic acid solution with a solid content of 20% was obtained after reacting for 12 hours in a water bath (at room temperature). After that, 30 ml of the polyamic acid solution was coated on a copper foil (the thickness thereof is 12 m) by a blade coating method, and was baked at 140° C. for 10 minutes to remove NMP. Then, the copper foil coated with the polyamic acid solution was placed in a nitrogen environment at 300° C. to perform a imidization reaction (dehydrating cyclization) for 30 minutes, so that the polyimide film placed on the copper foil of Comparative Example 1 was obtained, wherein the imidization ratio thereof is 100%. Finally, the copper foil was removed by etching to obtain the polyimide film of Comparative Example 1, wherein the thickness thereof is about 25 μm measured by performing a thickness measurement using a Litematic device (the series 318 Model VL-50A by Mitutoyo America Corporation).

After that, measurements of dielectric constant, dielectric loss, glass transition temperature, thermal decomposition temperature, tensile strength, elongation, elastic modulus, light transmittance, and value of CIE L*a*b* color space are conducted on the polyimide film of each of Examples 1-2 and Comparative Example 1. Also, measurement of peel strength is conducted on the polyimide film placed on the copper foil as provided in each of Examples 1-2 and Comparative Example 1. The above-mentioned measurements are illustrated below, and the results of the measurements are shown in Table 1.

### <Measurements of Dielectric Constant and Dielectric Loss>

First, the polyimide film of each of Examples 1-2 and Comparative Example 1 was made into a film material with length and width dimensions of 7 cm×10 cm. Next, each of the film materials was placed in an atmospheric environment for 7 days after placing in an oven to bake at 130° C. for 2 hours. After that, dielectric constant and dielectric loss of each of the film materials was measured by a dielectric constant measuring device (R&S®ZVB20V Vector Network Analyzer made by ROHDE & SCHWARZ Corporation) at measuring frequency of 10 GHz. In the standard setting in industry, the dielectric constant of the polyimide film is equal to or less than 3.2, and a lower value means a better dielectric property of the polyimide film. Also, the dielectric loss of the polyimide film is equal to or less than 0.01, and a lower value means a better dielectric property of the polyimide film.

### <Measurement of Glass Transition Temperature>

First, the polyimide film of each of Examples 1-2 and Comparative Example 1 was made into a film material with length and width dimensions of 5 mm×40 mm. Next, each of the film materials was heated from 30° C. to 450° C. in a nitrogen environment and under the condition that the heating rate was set at 10° C./minute by a dynamic mechanical analyzer (EXSTAR 6100 made by Seiko Instrument Inc.). The temperature measured when the loss tangent (tan δ) reached a maximum value was taken as the glass transition temperature (° C.). In the standard setting in industry, the glass transition temperature of normal polyimide films is equal to or more than 300° C., and a higher value means a better thermal stability of the polyimide film.

### <Measurement of Thermal Decomposition Temperature>

First, 3 mg to 8 mg of the polyimide film provided in each of Examples 1-2 and Comparative Example 1 was weighed and each weighed polyimide film was taken as a test film material. Next, each of the film materials was heated from 30° C. to 600° C. in a nitrogen environment and under the condition that the heating rate was set at 10° C./minute by a thermo-gravimetric analyzer (EXSTAR 6000 made by Seiko Instrument Inc.). The temperature measured when the weight loss of the film material was 5% is taken as the thermal decomposition temperature (° C.). In the standard setting in industry, the thermal decomposition temperature of the polyimide film is required to achieve 400° C. or more and a higher value means a better thermal stability of the polyimide film.

### <Measurements of Tensile Strength, Elongation, and Elastic Modulus>

First, the polyimide film of each of Examples 1-2 and Comparative Example 1 was made into a film material with length (an interval of marks) and width dimensions of 25.4 mm×3.2 mm and with a shape of dumbbell or dog bone. Next, tensile strength (MPa), elongation (%), and elastic modulus (GPa) of each of the film materials was measured by a universal testing machine (AG-1S made by the SHIMADZU Co. Ltd.).

Tensile strength represents the maximum strength that the film material can withstand in the process of stretching. In particular, tensile strength is the maximum engineering stress when the film material is stretched to the tensile length without breaking under the condition that the initial setting of the tensile strength is 0, wherein a higher value means a better mechanical property.

Elongation represents the deformation level when the film material is broken. In particular, elongation is the amount of deformation when the film material is stretched to break under the condition that the initial setting of the tensile strength is 0, wherein a higher value means a better mechanical property.

Elastic modulus (or called Young's Modulus) represents the indication of the difficulty level of the film material to appear elastic deformation, wherein a higher value means that the required stress for elastic deformation is higher. That is, stiffness of the material is higher. On the contrary, a lower value means a better flexibility or softness.

### <Measurement of Light Transmittance>

First, the polyimide film of each of Examples 1-2 and Comparative Example 1 was made into a film material with length and width dimensions of 10 cm×10 cm. Next, after each of the film materials was baked at 300° C. for 30 minutes, the light transmittance curve of the polyimide film of each of Examples 1-2 and Comparative Example 1 was measured at the wavelength in the range of 300 nm to 800 nm by a UV/Vis spectrometer (U4100 made by the HITACHI Company). In Table 1, 360 nm light transmittance (%) means the light transmittance at the wavelength of 360 nm; 370 nm light transmittance (%) means the light transmittance at the wavelength of 370 nm; 380 nm light transmittance (%) means the light transmittance at the wavelength of 380 nm; 400 nm light transmittance (%) means the light transmittance at the wavelength of 400 nm; 550 nm light transmittance (%) means the light transmittance at the wavelength of 550 nm.

### <Measurement of CIE L*a*b* Color Space>

First, the polyimide film of each of Examples 1-2 and Comparative Example 1 was made into a film material with length and width dimensions of 1 cm×1 cm. Next, after each of the film materials was baked at 300° C. for 30 minutes, values of L*, a*, and b* was measured by a spectroscopic colorimeter (KONICA sepctrotophotometer CM-2300D made by the Konica Minolta Company). In the standard setting in industry, a value of b* between −5 and 5 means a polyimide film without yellowing.

### <Measurement of Peel Strength>

First, the polyimide film provided in each of Examples 1-2 and Comparative Example 1 and disposed on the copper foil was cut together with the copper foil into a test sample with a width of 0.3175 mm. Next, each of the test samples was stretched to the tensile length of 30 mm by a universal testing machine (AG-1S made by Shimadzu Corporation) under the condition that the stretching rate was set at 50.8 mm/minute, and accordingly the peeling strength was determined. It should be noted that when the adhesive force between the polyimide film and the copper foil is larger, the interface between the two is less susceptible to break by external force. That is, in Table 1, a higher value of the peel strength means a better peel strength, and a better adhesive force between the polyimide film and the copper foil. In addition, in the standard setting in industry, the peel strength is more than 1.0 kgf/cm.

TABLE 1

| | | | Comparative |
|---|---|---|---|
| | Example 1 | Example 2 | Example 1 |
| Dielectric constant | 2.54 | 2.81 | 2.75 |
| Dielectric loss | 0.0087 | 0.0077 | 0.0095 |
| Glass transition temperature | 301 | 265 | 270, 347 |
| (° C.) | | | |
| Thermal decomposition | 459 | 456 | 464 |
| temperature (° C.) | | | |
| Tensile strength (MPa) | 116 | 111 | 134 |
| Elongation (%) | 5.6 | 32.5 | 2.4 |
| Elastic modulus (GPa) | 2.5 | 2.4 | 3.6 |
| 360 nm light | 78.1 | 40 | 36.3 |
| transmittance (%) | | | |
| 370 nm light | 80.7 | 71.1 | 55.7 |
| transmittance (%) | | | |
| 380 nm light | 81.4 | 78.1 | 70.4 |
| transmittance (%) | | | |
| 400 nm light | 84.2 | 81.4 | 83.1 |
| transmittance (%) | | | |
| 550 nm light | 90.5 | 88.9 | 89.8 |
| transmittance (%) | | | |
| UV cut-off wavelength (nm) | 320 | 340 | 330 |
| L* | 98.55 | 98.15 | 96.6 |
| a* | −0.61 | −0.68 | −0.70 |
| b* | 3.85 | 4.32 | 5.68 |
| Peel strength (kgf/cm) | 0.93 | 1.33 | 0.75 |
| Viscosity (cps) | 300 | 45,000 | 2,700 |

From Table 1, it can be known that the polyimide films of Examples 1-2 had good performances in dielectric constant, dielectric loss, glass transition temperature, thermal decomposition temperature, tensile strength, elongation, elastic modulus and viscosity. It means that the polyimide films of Examples 1-2 have good thermal and mechanical properties. Also, the polyimide film of Example 2 had an excellent performance in elongation.

In addition, from Table 1, it can be known that the polyimide film of Example 1 had better light transmittance and transparency compared to the polyimide film of Comparative Example 1. Specifically, from Table 1, it can be known that the polyimide film of Example 1 had excellent light transmittance whether in the UV region or in the visible region, and the polyimide film of Example 1 has no yellowing problem.

In addition, from Table 1, it can be known that although the polyimide film of Example 2 had the light transmittance similar to that of the polyimide film of Comparative Example 1 in the visible region, the polyimide film of Example 2 had the better light transmittance in the wavelength zone between 360 nm and 380 nm. Also, the polyimide film of Example 2 had no yellowing problem.

In addition, from Table 1, it can be known that the polyimide films of Example 1-2 had better adhesive force with copper foil compared to the polyimide film of Comparative Example 1. Also, the polyimide film of Example 2 had excellent adhesive force with copper foil.

Although the invention has been described with reference to the above embodiments, it will be apparent to one of ordinary skill in the art that modifications to the described embodiments may be made without departing from the spirit of the invention. Accordingly, the scope of the invention is defined by the attached claims not by the above detailed descriptions.

1. A polyimide comprising a repeating unit represented by formula 1: 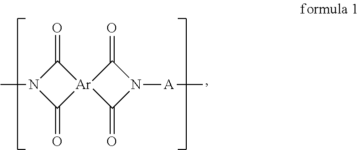
wherein
Ar is 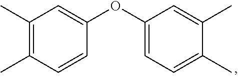
and
A is

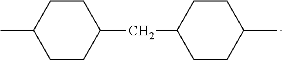

2. (canceled)

3. The polyimide according to claim 1, wherein a glass transition temperature of the polyimide is in a range of 250° C. to 350° C.

4. The polyimide according to claim 1, wherein a UV cut-off wavelength of the polyimide is in a range of 320 nm to 380 nm.

5. The polyimide according to claim 1, wherein the polyimide has a light transmittance of 70% or more at a wavelength of 370 nm.

6. The polyimide according to claim 1, wherein the polyimide has a light transmittance of 80% to 90% at a wavelength of 400 nm.

7. The polyimide according to claim 1, wherein the polyimide has a light transmittance of 85% to 95% at a wavelength of 550 nm.

8. The polyimide according to claim 1, wherein the polyimide has a C.I.E(L*a*b*) color space value and a value of L* is in a range of 94 to 99, a value of a* is in a range of −2.5 to 1, and a value of b* is in a range of −5 to 5.

9. The polyimide according to claim 1, wherein the polyimide has a viscosity in a range of 150 to 50,000 cps.

10. A polyimide film, comprising the polyimide according to claim 1.
